(19) United States
(12) Patent Application Publication
(10) Pub. No.: US 2021/0196025 A1
(43) Pub. Date: Jul. 1, 2021

(54) FLUID PRODUCT DISPENSER

(71) Applicant: APTAR FRANCE SAS, LE NEUBOURG (FR)

(72) Inventors: Stephane DAVIOT, Ferrieres Haut Clocher (FR); Frédéric DUQUET, Crespieres (FR); Francis MOREAU, Sotteville Les Rouen (FR)

(73) Assignee: APTAR FRANCE SAS, LE NEUBOURG (FR)

(21) Appl. No.: 17/057,788

(22) PCT Filed: May 23, 2019
(86) PCT No.: PCT/FR2019/051181

§ 371 Date: Nov. 23, 2020

(30) Foreign Application Priority Data
May 25, 2018 (FR) 1854455

(51) Int. Cl. A45D 34/04; B65D 51/32; B05B 11/00

(52) U.S. Cl. CPC A45D 34/045; B65D 51/32; A45D 2200/1018; B05B 11/3074; A45D 2200/056; B05B 11/3023

(57) ABSTRACT

A fluid dispenser comprising:
a fluid reservoir (R);
a pump (P) having a pump body (P1), a return spring (P2), and an actuator rod (P3) that is axially movable down and up between an extended rest position and a depressed actuated position;
a cup (1) for collecting the fluid coming from the pump (P), the cup (1) being mounted on the actuator rod (P3); and
a removable member (2) that is removable along an axial direction, said removable member including an applicator (A) that is received in the cup (1) so as to pick up the fluid, the applicator (A) being elastically deformable and constrained inside the cup (1) by locking means (23, 31);
said fluid dispenser being characterized in that the locking means are locking means (23, 31) that lock by turning, and that include a plurality of stationary flanges (31) that are secured to the reservoir (R), and the removable member (2) includes a plurality of fins (23) that are suitable for coming into engagement beneath the stationary flanges (31).

The present invention relates to a fluid dispenser comprising a fluid reservoir and a pump having a pump body, a return spring, and an actuator rod that is axially movable down and up between an extended rest position and a depressed actuated position. The dispenser also comprises a cup for collecting the fluid coming from the pump, the cup being mounted on the actuator rod of the pump. The dispenser also comprises a removable member including an applicator that is received in the cup so as to pick up fluid.

Thus, the user may take hold of the reservoir with one hand and remove the grip member with the other hand so as to be able to apply the fluid picked up by the applicator onto a desired application surface, e.g. the skin, the hair, the nails, etc. The preferred field of application of the present invention is the field of cosmetics, without however excluding perfumery, pharmacy, and hair care.

In the prior art, document FR 3 023 269 is known, which describes a fluid dispenser of that type, comprising a reservoir, a pump that is mounted on the reservoir, and a pusher that is mounted on the pump so as to actuate it. The pusher comprises a cup that is mounted on the actuator rod of the pump, and a grip member that is mounted in removable manner on the cup. The grip member includes a porous applicator that is housed freely in the cup. The grip member defines a bearing surface on which it is possible to press axially so as to move the cup and thus actuate the pump so as to load the porous applicator with fluid.

Using that prior-art dispenser requires a hand movement that is neither simple nor intuitive. Specifically, the user must initially press on the grip member so as to load the applicator with fluid. It is only after that initial operation that the user can then remove the grip member (with its applicator) from the cup, which cup remains secured to the actuator rod of the pump. If the user actuates the pump a plurality of times, excess fluid builds up in the cup, and cannot be picked up by the applicator. While putting the grip member back into place, there is the risk of the excess fluid being forced out of the cup and soiling the dispenser.

The present invention seeks to improve that type of dispenser by making it simpler to handle and by avoiding any excessive dispensing. Another object is to load the applicator with a dose that is accurate, reproducible, and constant. Still another object is to ensure that fluid is distributed in uniform and widespread manner over the surface of the applicator. Still another object is to provide an applicator having an application surface of area that is large, but without using a cup of corresponding size. Another object is to provide an applicator that is easy to clean or replace. Another object is to guarantee that the dispenser is leaktight.

To do this, the present invention makes provision for the applicator to be elastically deformable and for it to be constrained inside the cup by locking means. Thus, when the removable member is in place on the cup, the applicator presents a volume, and as a result a surface area, that are small compared to the volume and surface area when the applicator is not constrained in any way. The applicator relaxes towards its rest configuration when it is removed from the cup, which cup performs the function of a confinement chamber confining the applicator by deforming it elastically in reversible manner.

Furthermore, the locking means are locking means that lock by turning about the axis of the dispenser, advantageously through an angle of about 60°. The locking means include a plurality of stationary flanges that are secured to the reservoir, and the removable member may include a plurality of fins that are suitable for coming into engagement beneath the stationary flanges.

Advantageously, the fins are urged against the stationary flanges by the return spring of the pump.

The operation of putting the applicator back into place thus takes place as follows: the user inserts the applicator into the cup, presses the applicator into and against the cup so as to move said cup against the return spring of the pump, and then turns the removable member relative to the reservoir until the fins are positioned beneath the stationary flanges. While doing this, the pump is actuated: a dose of fluid is forced into the cup that is filled by the applicator. As a result, the fluid is constrained to spread out between the cup and the applicator, which ensures that the fluid is distributed in widespread manner over all of the surface of the applicator, or at least over most of it. Preferably, the applicator comprises a foam having closed cells, so that it is coated with fluid, but is not impregnated deeply with fluid.

The operation of removing the applicator takes place as follows: the user turns the removable member until the fins become disengaged from beneath the stationary flanges: the return spring then immediately pushes the cup and the removable member, which removable member can then be removed easily from the cup.

Advantageously, the actuator rod is in its depressed actuated position when the applicator is constrained inside the cup by the locking means. This means that the pump remains actuated, with its outlet valve possibly open. This implies that a dose of fluid is forced into the cup each time the applicator is put back into place in the cup, under the effect of the locking means. During removal of the applicator, the return spring of the pump returns the actuator rod and its cup into the extended rest position: the outlet valve is then closed once again. The user is not even aware that a pump has been actuated: the user does not even need to know that a pump is incorporated in the dispenser. It suffices for the user to remove the removable member and to put it back into place in order to ensure that the applicator is loaded in accurate and sufficient manner.

According to an advantageous characteristic, the applicator presents a rest axial height when it is not constrained inside the cup, and a smaller axial height when it is constrained inside the cup by the locking means, the smaller axial height representing less than 90%, advantageously less than 70%, and preferably about 50% of the rest axial height. According to one definition, the applicator may present a compression ratio, both axially and radially, of at least 25%. This means that the applicator can decrease in volume, and as a result in surface area, to a significant extent, which greatly exceeds residual deformation of the order of a few %. With certain appropriate materials, the compression ratio, may reach more than 50%. Advantageously, the applicator fills the cup completely, when it is constrained therein by the locking means.

The operation of putting the applicator back into place thus takes place as follows: the user inserts the applicator into the cup, presses the applicator into and against the cup so as to move said cup against the return spring of the pump, and then turns the removable member relative to the reservoir until the fins are positioned beneath the stationary flanges. While doing this, the pump is actuated: a dose of fluid is forced into the cup that is filled by the applicator. As a result, the fluid is constrained to spread out between the cup and the applicator, which ensures that the fluid is distributed in widespread manner over all of the surface of the applicator, or at least over most of it. Preferably, the applicator comprises a foam having closed cells, so that it is coated with fluid, but is not impregnated deeply with fluid.

The operation of removing the applicator takes place as follows: the user turns the removable member until the fins become disengaged from beneath the stationary flanges: the return spring then immediately pushes the cup and the removable member, which removable member can then be removed easily from the cup.

According to another advantageous characteristic of the invention, the dispenser includes a vent passage that makes it possible for outside air to penetrate into the reservoir, the vent passage being closed by the cup when it is in the depressed actuated position. This avoids any risk of fluid leaking when the dispenser is stored in a position or in conditions that is/are inappropriate.

In an advantageous aspect, the cup may include a projecting sealing bead, the applicator being deformed around the projecting sealing bead when it is constrained inside the cup by the locking means. This avoids or minimizes any risk of fluid leaking from the cup.

Advantageously, the cup has a substantially rounded shape, and the applicator is substantially conical or bullet-shaped at rest, the applicator deforming in the cup until it takes on the rounded shape of the cup, the applicator advantageously forming a tip that alone is likely to come into contact with the cup, when said applicator is not constrained inside the cup. The applicator may also form one or more plane faces. The shape of the applicator should be adapted as a function of the fluid that is to be dispensed and of the nature of the target.

In a practical aspect, the removable member may comprise a grip element and an applicator support in which the applicator is mounted, the grip element being mounted in removable manner on the applicator support. It is thus possible to remove the applicator support (with its applicator) from the grip element so as to clean it or replace it. By way of example, it is possible to provide a plurality of identical or different applicators in a kit.

The spirit of the invention resides in elastically compressing the applicator into its cup by means of any locking system. The simultaneous and imperceptible actuation of the pump greatly simplifies the hand movements needed for using the dispenser. A high compression ratio makes it possible to have an applicator of appropriate size, even though the dispenser is small in size.

The invention is described more fully below with reference to the accompanying drawings, which show an embodiment of the invention by way of non-limiting example.

In the figures:

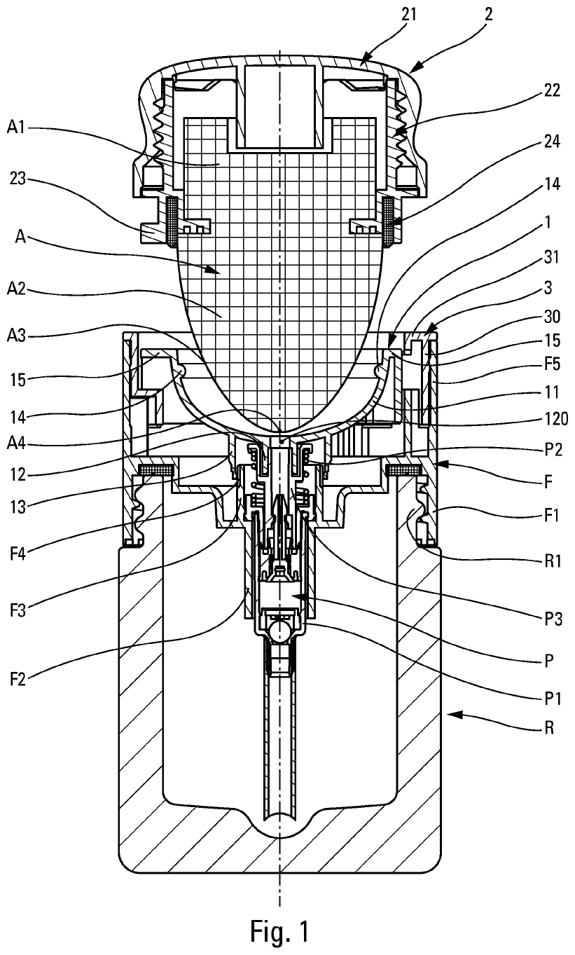

FIG. 1 is a vertical section view through a dispenser of the invention, in its open state;

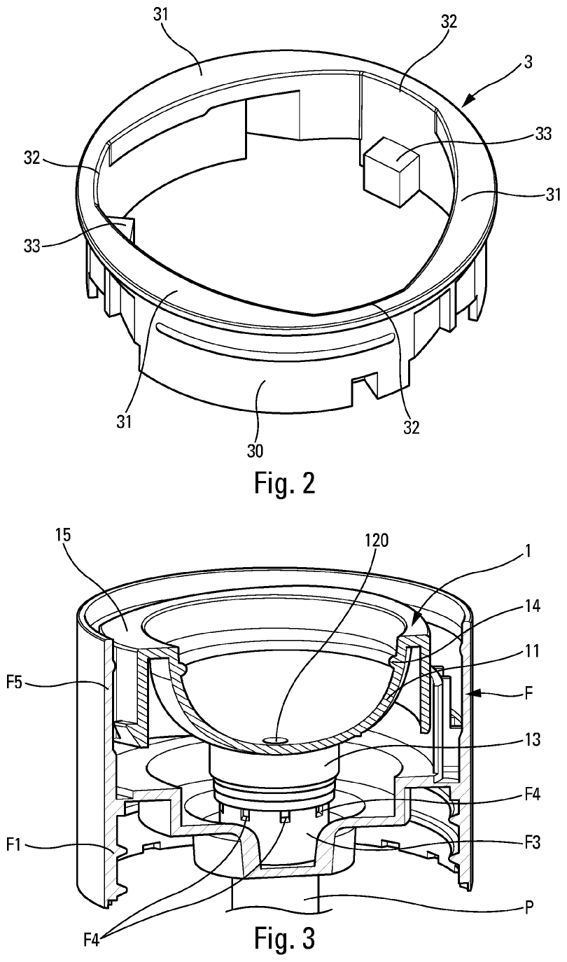

FIG. 2 is a larger-scale perspective view of the locking ring of the invention;

FIG. 3 is a larger-scale perspective view of a portion of the dispenser in its open state;

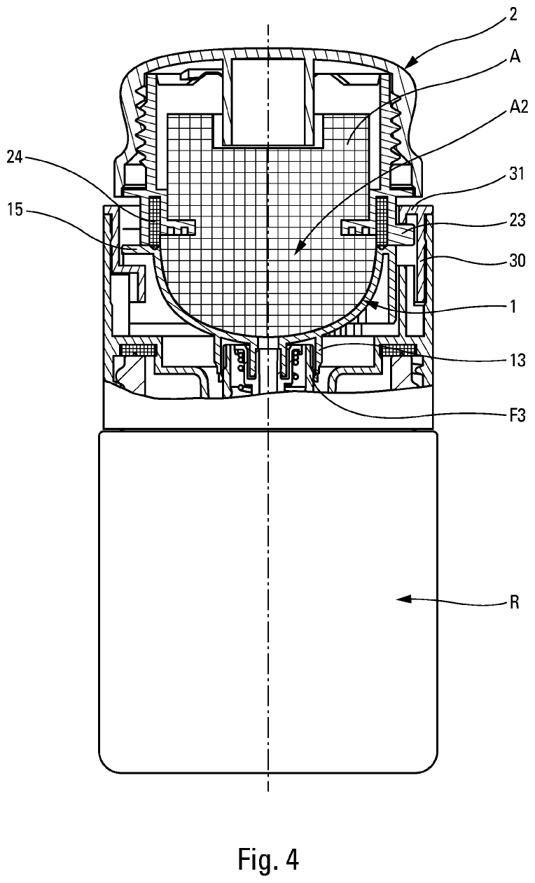

FIG. 4 is a view partially in vertical section through the dispenser of the invention, locked in its closed state;

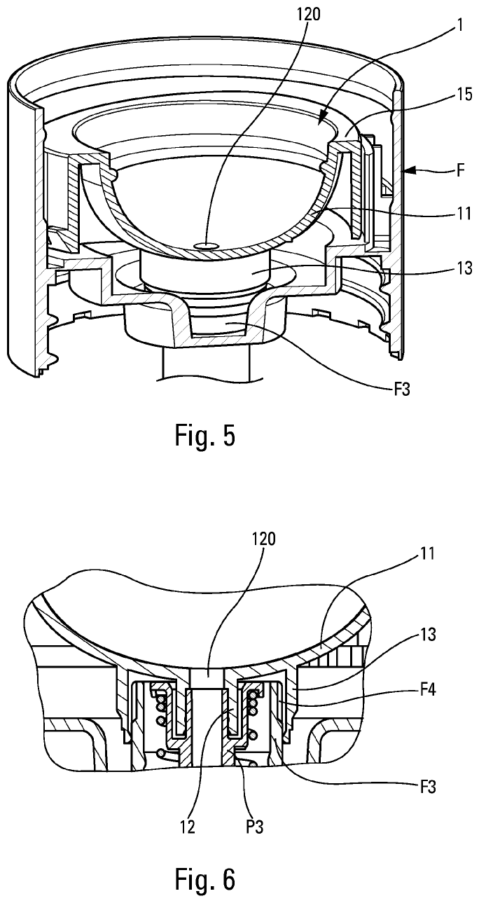

FIG. 5 is a view similar to the view in FIG. 3 locked in its closed state; and

FIG. 6 is a larger-scale view of a detail of FIG. 4.

As can be seen in FIG. 1, the dispenser comprises the following component elements, namely a fluid reservoir R, a pump P, a fastener sleeve F, a cup 1, a removable member 2, and a locking ring 3.

The reservoir R and the pump P are not critical elements for the present invention. The reservoir R can be made of any appropriate material, such as glass, plastics material, metal, etc. The reservoir R defines an opening in the form of a neck R1.

The pump P is a conventional pump comprising a pump body P1, a return spring P2, and an actuator rod P3 that moves down and up in the pump body P1 against the return spring P2, between an extended rest position and a depressed actuated position.

For fastening on the neck R1, the fastener sleeve F receives the pump body P1 in stationary manner, and the fastener sleeve is then fastened on or around the neck R1 in stationary and leaktight manner. More precisely, the fastener sleeve F includes an assembly section F1 that comes into engagement, e.g. threaded engagement, with the neck R1. It also includes a reception section F2 in which the pump body P1 is fitted. It also forms a vent section F3 that includes vent grooves F4, which together constitute a vent passage that puts the outside into communication with the inside of the reservoir R, passing via the pump P. The fastener sleeve F also includes a support section F5 that, in this embodiment, extends in line with the assembly section F1. The support section F5 receives the locking ring 3 that is described below.

In the invention, the cup 1 is mounted on the pump P so as to collect the fluid dispensed by the pump. The cup 1 includes a connection sleeve 12 that comes into engagement with the free end of the actuator rod P3 of the pump P. The sleeve 12 is extended by a feed orifice 120 that opens out into the bottom of a reception dish 11 that may present the shape of an upsidedown dome that is rounded, being substantially hemispherical in the figures, but that could equally well be bullet-shaped, oblong, or egg-shaped. Advantageously, an annular sealing bead 14 is formed at the reception dish 11. Around the sleeve 12 there extends a skirt 13 that is engaged around the vent section F3, as can be seen in FIG. 3. At its top end, the cup 1 forms an annular rim 15 that projects radially outwards. At this point, it should be understood that moving the cup 1 downwards towards the pump P causes the actuator rod P3 to be depressed, thereby causing fluid to be dispensed through the rod P3, then through the feed orifice and into the dish 11. Although not shown, the cup 1 is also guided in its axial movement and prevented from turning. Such axial guidance and prevention from turning are provided between the cup 1 and the locking ring 3.

In the invention, the locking ring 3 is engaged, e.g. by snap-fastening, in the support section F5 of the sleeve F. To this end, the ring 3 forms a fastener sleeve 30 that may be provided with a snap-fastener profile, as can be seen in FIG. 2. The ring 3 also forms three stationary flanges 31 that are crescent shaped and that are arranged in a triangle. The flanges 31 project inwards and they are arranged at 120° relative to one another. Between two adjacent flanges, an access notch or slot 32 is formed, such that there are as many access slots 32 as there are flanges 31, and they are likewise arranged at 120° relative to one another. The flanges 31 may be spaced apart from one another by the access slots 32 or they may be touching, in such a manner that the access slots 32 are formed at the junctions of two adjacent flanges. The flanges 31 and the slots 32 co-operate with one another to form a shaped inner edge roughly in the shape of a triangle with sides that curve outwards and vertices that are truncated or blunt. The number of flanges and slots is not limiting. In FIG. 2, it can also be seen that the ring 3 forms axial guide lugs 33 that co-operate with the cup so as to hold it on the axis and also so as to prevent it from turning.

In the invention, the removable member 2 is a distinct upper sub-assembly for co-operating with the other sub-assembly beneath it as constituted by the reservoir R, the pump P, the fastener sleeve F for fastening the cup 1, and the locking ring 3. The removable member 2 includes a grip element 21 for being gripped by the user so as to manipulate the removable member. The removable member 2 may include a gasket 24 that comes to be flattened against the rim 15 of the cup 1 in the closed position of the dispenser. The removable member 2 also includes an applicator support 22 in which an applicator A is mounted. More precisely, the applicator A includes an internal anchor portion A1 and an external application portion A2 that defines an application surface A3 and a tip A4. In this embodiment, the application surface A3 is bullet-shaped. In a variant, the application surface may be conical, or even cylindrical. It may also form one or more plane faces. Advantageously, the grip element 21 is mounted in removable manner, e.g. by screw-fastening, on the applicator support 22, so that the applicator support 22 (and its applicator A) can be removed from the grip element 21 so as to clean the applicator A or so as to replace the applicator support 22 (and its applicator A). In the invention, the applicator support 22 forms three projecting fins 23 that are arranged at 120° relative to one another. The fins 23 may be crescent shaped, corresponding to, or similar to, the shape of the flanges 31. Together they thus form a shaped outer edge roughly in the shape of a triangle with sides that curve and vertices that are rounded or blunt, corresponding to, or similar to, the shape of the flanges 31, but of a size that is a little smaller, so as to be capable of being inserted into the shaped inner edge of the flanges 31. The three fins 23 are for co-operating with the locking ring 3 and the rim 15. More precisely, the three fins 23 need to be oriented angularly so as to be inserted between the flanges 31 and in the three access slots 32 of the ring 3. The fins 23 thus come to bear against the rim 15 of the cup 1. By pressing axially on the removable member, the cup 1 moves downwards until the fins 23 are situated axially below the stationary flanges 31. It is then possible to turn the removable member so as to engage the fins 23 beneath the flanges 31. The removable member is then in its locked position, being locked by mutual engagement of the fins 23 and the flanges 31, that co-operate to form locking means. The fins and the flanges may be plane, or, on the contrary, they may form cam surfaces, so as to drive axial movement when the removable member is turned.

In the invention, the applicator A is made of an elastically-deformable material that returns to its initial shape. The material presents a compression ratio of at least 25%, or even 50%. Compression occurs axially and/or radially. The external application portion A2 presents a “rest” axial height when the applicator A is not constrained inside the cup 1, and a smaller axial height when it is constrained inside the cup 1 by the locking means 26, 31, the smaller axial height representing less than 90%, advantageously less than 70%, and preferably about 50% of the rest axial height. It can easily be understood that the area of the application surface A3 varies in corresponding manner with the variation in volume of the applicator. As a result, an applicator A is available with an application surface of area that is large, even though the dish 11 of the cup is significantly smaller. Advantageously, the material used for the applicator A is a foam having closed cells, which foam does not become impregnated with fluid, but is merely coated with fluid.

A complete operating cycle of the dispenser of the invention is described below, starting from FIG. 1. The removable member 2 is completely removed and separate from the cup 1. Its applicator A is in a rest configuration in which its volume and the area of its application surface A3 are at their maximum. In addition, the pump P is at rest, with its actuator rod P3 in its extended rest position. The bottom of the skirt 13 of the cup 1 is positioned at the vent grooves F4 of the vent section F3, as can be seen in FIG. 3. The reservoir R is then in communication with the outside through the pump P. In FIG. 1, it is possible to observe the considerable difference in volume between the dish 11 and the external portion A2 of the applicator.

In order to put the removable member 2 into place on the lower sub-assembly of the dispenser, it is necessary initially to engage the applicator A in the dish 11 of the cup 1. The tip A4 of the external portion A2 comes into contact firstly with the cup 1, at the bottom of the dish 11 where the feed orifice is formed. Subsequently, the tip A4 can be used to recover fluid that remains in the dish 11. By being pressed against the cup, the applicator A deforms so as to extend the area of contact between them. The applicator A ends up by filling the dish 11 completely. In other words, its entire application surface A3 comes into contact with the dish 11. The applicator A deforms against and around the sealing bead 14, so as to form annular sealing in the proximity of the top edge of the dish 11. The applicator is fully compressed when the fins 23 come into contact with the rim 14 between the flanges 31 and in the access slots 32. By continuing to press on the removable member 2, the cup 1 is moved, driving the actuator rod P3 against the return spring P2. This axial movement of the cup 1 causes three events, namely:
the fins 23 are positioned axially below the stationary flanges 31, so that it is then possible to turn the removable member, e.g. through 60°, so as to position the fins 23 directly beneath the flanges 31, as can be seen in FIG. 4;
the pump P delivers a dose of fluid that is forced into the cup 1 and spreads out between the dish 11 and the applicator A. By selecting an appropriate pump P, it is possible to ensure that the dose of fluid enables the entire application surface A3 of the applicator A to be coated; and
the skirt 13 of the cup 1 comes to cover the vent grooves F4, as shown in FIGS. 5 and 6, thereby cutting off communication between the reservoir R and the outside.

The dispenser is thus locked in this position, with the applicator loaded, the pump actuated, and the vent cut off, as shown in FIG. 4. This position is completely stable, as a result of the fins 23 being urged against the flanges 31 by the action of the return spring P2.

When the user wishes to use the dispenser again, it suffices for the user to grip the removable member 2 and to turn it through 60° in the opposite direction, so as to release the fins 32 from beneath the flanges 31. The return spring P2 then immediately pushes the cup 1 and the fins 32 through the access slots. Then, it only remains for the user to remove the applicator from the cup.

It should be observed that the locking means of the invention are advantageous, since they make use of the return spring P2 of the pump P. However, it is possible to replace these locking means with other locking means, e.g. using screw-fastening, snap-fastening, clamping, or magnets.

The pump is preferably actuated when the applicator A is already completely compressed. However, in a variant, it is possible to envisage the pump being actuated before the applicator is compressed in the cup, or while it is being compressed therein.

The invention thus provides a fluid dispenser and applicator having locking means that make it possible to obtain the following advantages:
an applicator that is large compared to the size of the dispenser;
distribution of the fluid over all of the application surface, or over most of it;
easy recovery of the fluid in the cup;
automatic and imperceptible actuation of the pump;
guaranteed locking under the action of the return spring;
simple and intuitive hand movements;
leaktight at rest; and
easy cleaning or replacement of the applicator.

1. A fluid dispenser comprising:
a fluid reservoir;
a pump having a pump body, a return spring, and an actuator rod that is axially movable down and up between an extended rest position and a depressed actuated position;
a cup for collecting the fluid coming from the pump, the cup being mounted on the actuator rod; and
a removable member that is removable along an axial direction, said removable member including an applicator that is received in the cup so as to pick up the fluid, the applicator being elastically deformable and constrained inside the cup by locking means;
wherein the locking means are locking means that lock by turning, advantageously through an angle of about 60°, the locking means include a plurality of stationary flanges that are secured to the reservoir, and the removable member includes a plurality of fins that are suitable for coming into engagement beneath the stationary flanges.

2. A fluid dispenser according to claim 1, wherein the fins are urged against the stationary flanges by the return spring of the pump.

3. A fluid dispenser according to claim 1, wherein the actuator rod is in its depressed actuated position when the applicator is constrained inside the cup by the locking means.

4. A fluid dispenser according to claim 1, wherein the applicator presents a rest axial height when it is not constrained inside the cup, and a smaller axial height when it is constrained inside the cup by the locking means, the smaller axial height representing less than 90%, advantageously less than 70%, and preferably about 50% of the rest axial height.

5. A fluid dispenser according to claim 1, wherein the applicator presents a compression ratio, both axially and radially, of at least 25%.

6. A fluid dispenser according to claim 1, wherein the applicator fills the cup completely, when it is constrained therein by the locking means.

7. A fluid dispenser according to claim 1, including a vent passage that makes it possible for outside air to penetrate into the reservoir, the vent passage being closed by the cup when it is in the depressed actuated position.

8. A fluid dispenser according to claim 1, wherein the cup includes a projecting sealing bead, the applicator being deformed around the projecting sealing bead when it is constrained inside the cup by the locking means.

9. A fluid dispenser according to claim 1, wherein the cup has a substantially rounded shape, and the applicator is substantially conical or bullet-shaped at rest, the applicator deforming in the cup until it takes on the rounded shape of the cup, the applicator advantageously forming a tip that alone is likely to come into contact with the cup, when said applicator is not constrained inside the cup.

10. A fluid dispenser according to claim 1, wherein the removable member comprises a grip element and an applicator support in which the applicator is mounted, the grip element being mounted in removable manner on the applicator support.
